(19) United States
(12) Patent Application Publication
(10) Pub. No.: US 2016/0076283 A1
(43) Pub. Date: Mar. 17, 2016

(54) ROTARY LEVER LOCK

(71) Applicant: DIRAK Dieter Ramsauer Konstruktionselemente GmbH, Ennepetal (DE)

(72) Inventors: Dieter Ramsauer, Schwelm (DE); Matthias Velten, Much (DE)

(73) Assignee: DIRAK Dieter Ramsauer Konstruktionselemente GmbH, Ennepetal (DE)

(21) Appl. No.: 14/787,829

(22) PCT Filed: Mar. 15, 2014
(86) PCT No.: PCT/EP2014/000694

§ 371 Date: Oct. 29, 2015

(30) Foreign Application Priority Data
May 2, 2013 (DE) 20 2013 004 046.7

(51) Int. Cl. E05C 3/14; E05B 35/00; E05B 41/00; E05B 5/00; E05C 3/12; E05B 33/00

(52) U.S. Cl. CPC E05C 3/145; E05C 3/12; E05B 33/00; E05B 41/00; E05B 5/00; E05B 35/00

(57) ABSTRACT

The description relates to a rotary latch closure comprising a housing (12) with an actuating shaft (14) which is mounted so as to be rotatable but axially fixed therein and which has at its free end (30) a circumferential thread (24) and at least one axially oriented flattened portion (26), and a rotary latch (28) which can be fitted to the free end (30) of the shaft so as to be fixed with respect to rotation relative to it in at least one rotational position and which is axially supported on a nut (32) which can be screwed onto the circumferential thread (24), characterized in that the nut (32) is enclosed by a cage (48) forming a laterally accessible space (46) that is bounded by two walls (42, 44), each of the two walls (42, 44) having a prismatic opening (40), wherein the opening allows the shaft (30) to be slid through in a torsionally rigid manner.

### TECHNICAL FIELD

The invention is directed to an adjustable cam for a rotary latch closure, key closure, swivel lever closure and T-handle which comprises a housing with an actuating shaft which is mounted so as to be rotatable but axially fixed therein and which has at its free end a circumferential thread and at least one axially oriented flattened portion, and a rotary latch which can be fitted to the end of the shaft in at least one rotational position so as to be fixed with respect to rotation relative to it and which is axially supported on a nut which can be screwed onto the circumferential thread. A rotary latch closure of this type is known from EP 1 723 299 B1.

### PRIOR ART

In the known rotary latch closure, swivel lever closure or key closure, a spring ensures that the rotary latch is held in a fixed position. However, a spring is a critical component part; it is prone to rust and laborious to install, particularly in switch cabinets which are to be provided with a closure. In switch cabinets of this kind, it is very risky to use any components made of metal as non-captive parts because this can lead to short-circuiting in a switch cabinet.

### OBJECT OF THE INVENTION

It is the object of the invention to avoid these disadvantages.

### DISCLOSURE OF THE INVENTION

The above-stated object is met according to the invention in that the nut is enclosed by a cage forming a laterally accessible space that is bounded by two walls, each of the two walls having an opening which allows the shaft to be slid through in a torsionally rigid manner.

The rotary latch closure, particularly with actuation by means of a key, a swivel lever or T-handle, makes do without spring devices and is therefore well-suited for applications in which the spring could be lost during assembly.

According to an embodiment form of the invention, the cage is integral with the latch cam. Instead of this, the cage and the latch cam can also be two parts, which has the advantage that different materials can be used for the two parts, e.g., metal and plastic.

A rotary latch closure in which the cage is U-shaped and the walls of the cage form U-legs has proven especially successful. The one leg of the U-shaped cage can form a recess or projection near its free end in which a projection or recess of the rotary latch can be received in a positive engagement. The other leg of the U-shaped cage can form a knob which can engage with recesses in the contacting lateral surface of the nut for preventing rotation. This eliminates the risk of the nut moving out of its required position as the result of shaking. On the other hand, the other leg of the U-shaped cage can form a knob which engages with recesses in the contacting lateral surface of the nut in order to prevent rotation thereof. Tilting forces also result in preventing rotation of the nut.

When it is U-shaped, the cage can form a protrusion at its free end at the U-leg facing the housing, which protrusion cooperates with a path which is formed by the end of the housing and which has two stop faces for limiting the rotational path.

When the walls of the cage retract transverse to the extension of the latch and a knurling of the circumference of the nut is accordingly made accessible, the knurled nut can be more easily adjusted by the fingers.

It is also advantageous when the cage is U-shaped and the nut, together with the rotary latch, can be inserted into the cage along the axis of the U-leg.

### BRIEF DESCRIPTION OF THE DRAWINGS

The invention will be described more fully with reference to embodiment examples which are illustrated in the drawings.

The drawings show:

FIG. 1A a rotary latch closure installed in a cabinet door which is held by a cabinet frame;

FIG. 1B a side view of a rotary latch according to a first embodiment form of the invention;

FIG. 1C a top view of a pinion which is shown in a side view in FIG. 1D;

FIG. 1D a side view of the rotary latch in question;

FIG. 2A a side view of another embodiment form of the invention in partial section;

FIG. 2B a side view of the other embodiment form of the invention from the rear;

FIG. 2C a perspective view of this closure;

FIG. 2D an exploded view of this embodiment form according to FIG. 2C;

FIG. 2E a side view of this embodiment form;

FIG. 3A a perspective view of another embodiment form of the invention;

FIG. 3B an exploded view of the latter embodiment form;

FIG. 3C a side view of this rotary latch closure;

FIG. 4 a perspective view of a swivel lever closure according to the invention; and

FIG. 5 a perspective view of a T-handle.

### BEST MODES FOR CARRYING OUT THE INVENTION

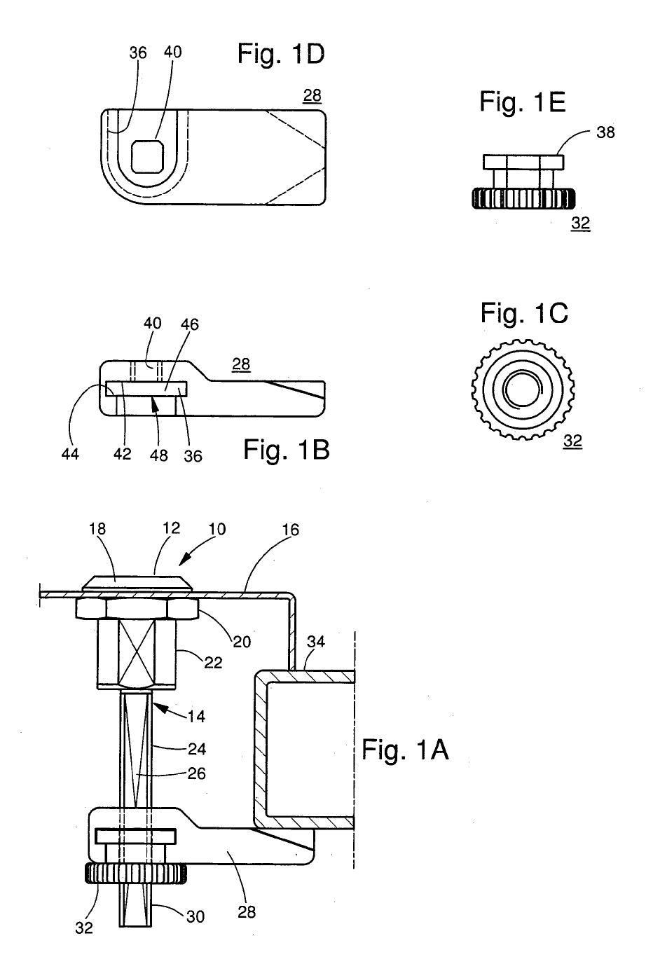

FIG. 1A shows a rotary latch closure 10 comprising a housing 12 with an actuating shaft 14 which is mounted so as to be rotatable but axially fixed therein. The housing is inserted through an opening at a door leaf 16 up to a flange 18 and is held by means of a retainer nut 20 which is screwed onto an external thread 22 of the housing 12 and holds the housing in the door leaf. It is also possible to fasten the housing to the door leaf in other ways, for example, by means of a clip fastener or a spring that can be inserted from the side.

The actuating shaft 14 has a circumferential thread 24 and an axially oriented flattened portion 26. A rotary latch 28 is fitted to the end 30 of the shaft 14 and, with a necked-down portion at one location together with the flattened portion of the shaft, is fixed with respect to relative rotation but, on the other hand, is displaceable in axial direction on the shaft. The rotary latch 28 is supported in the direction of the end of the shaft 30 by a knurled nut 32 such that by screwing in the nut the rotary latch 28 is fixed, e.g., in direction of the door frame 34, by the knurled nut, and the latch 28 is accordingly fixed in direction of the door leaf 16, whereas, in the opposite direction, the latch is held by ring arrangement 34 proceeding from the knurled nut 32, which ring arrangement 34 engages in a corresponding annular groove 36 of the knurled cam. As can be seen from FIG. 1D, the knurled nut 32 with the ring 38 can be inserted laterally into the cam 28, whereupon the shaft 14 can be inserted through the opening 38. By turning the knurled nut 32, the cam 28 can be displaced axially in both directions in order to ensure a snug contact of the latch 28 at the frame 34.

Accordingly, in this embodiment form, part of the nut 32, namely, the ring 38, is enclosed by a cage 36 which forms a space which is accessible from the side (see FIG. 1D) and which is bounded by two walls 42, 44 which have a prismatic opening in each instance so that the opening allows the shaft to be slid through in a torsionally rigid manner.

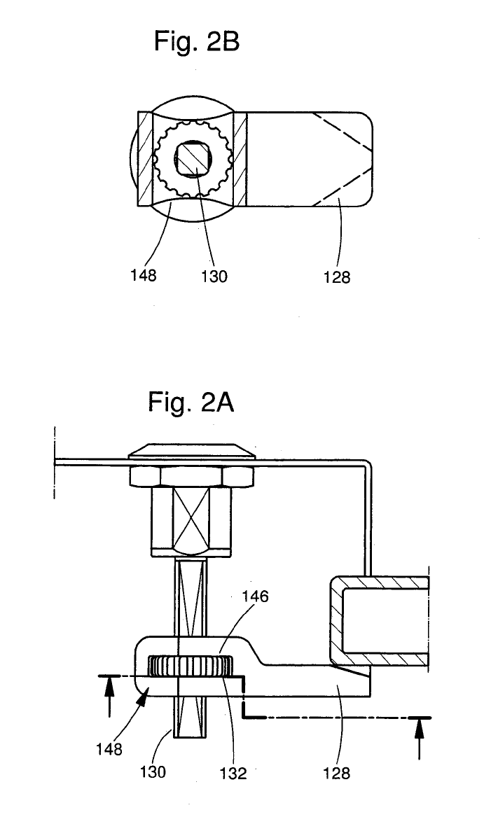

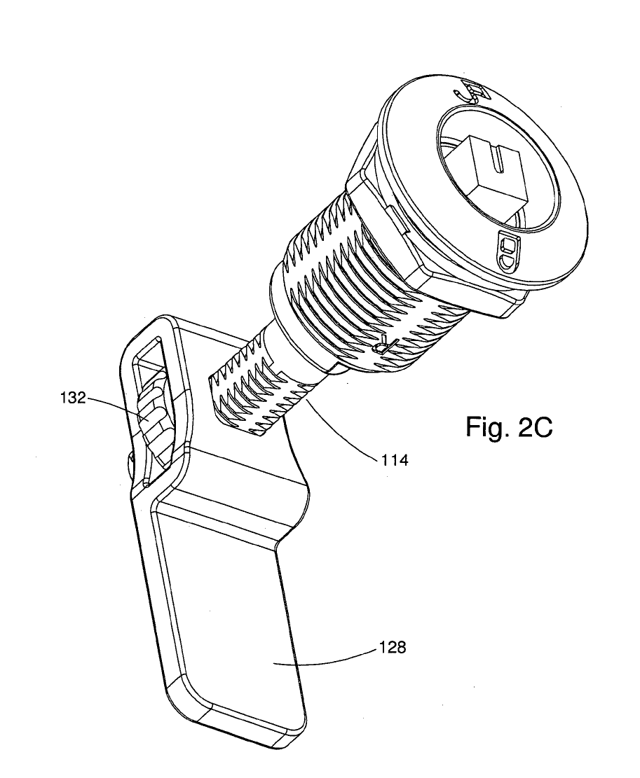

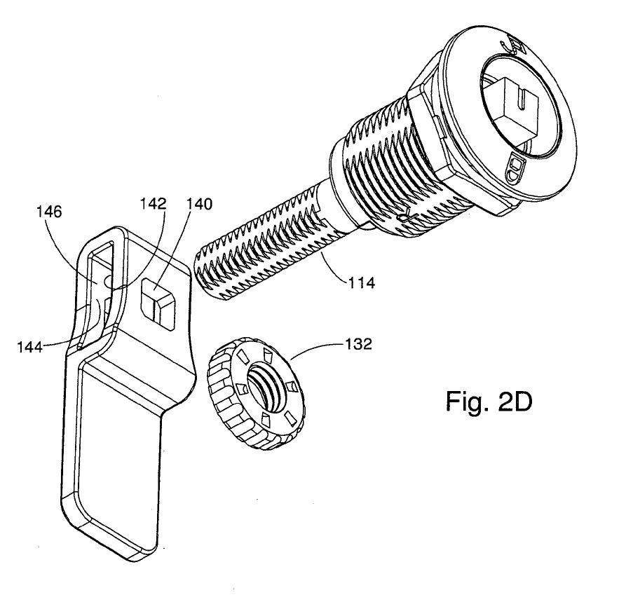

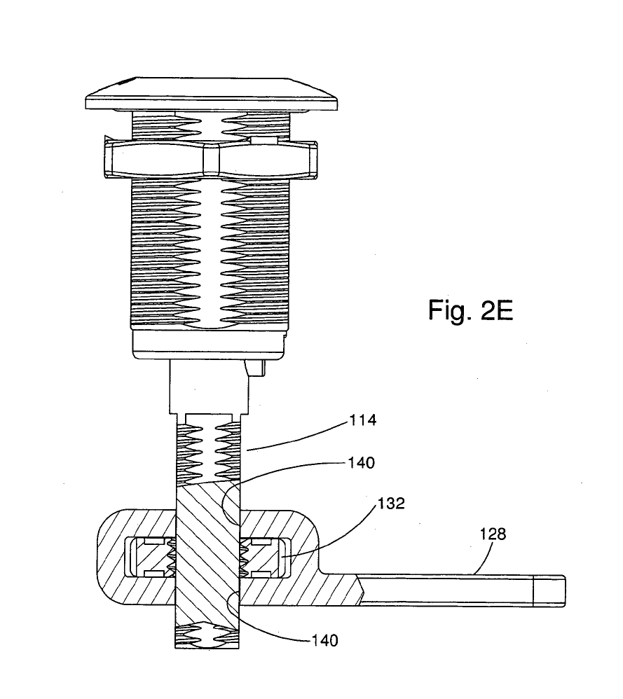

The cage 46 surrounding the annular groove 38 is integral with the latch cam 28. In the embodiment form in FIG. 2A, the knurled nut 32 is also slid in laterally, whereupon the shaft with its thread can be inserted through the openings 140 in the walls 142, 144 and the nut 132 can be turned at the same time.

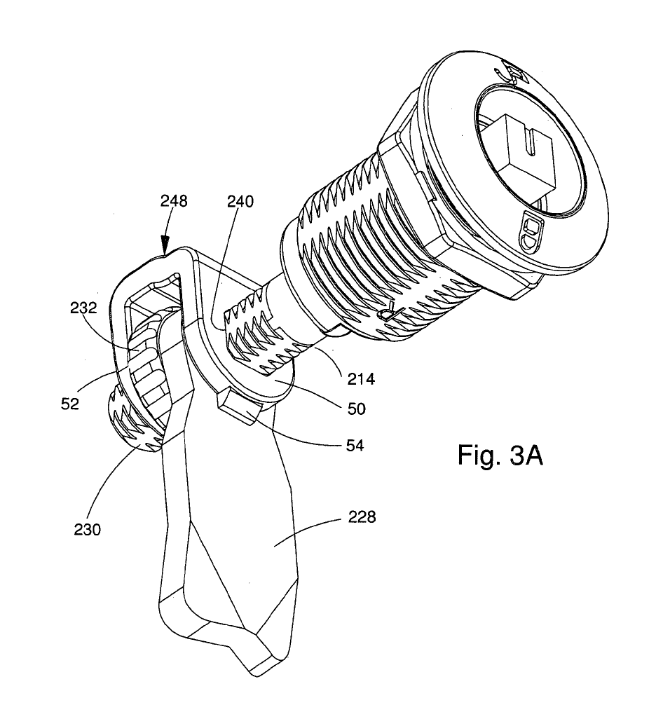

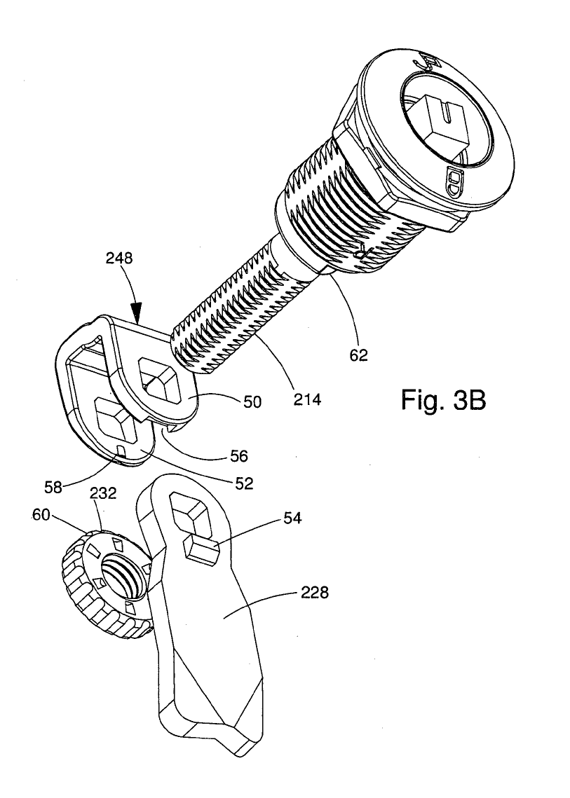

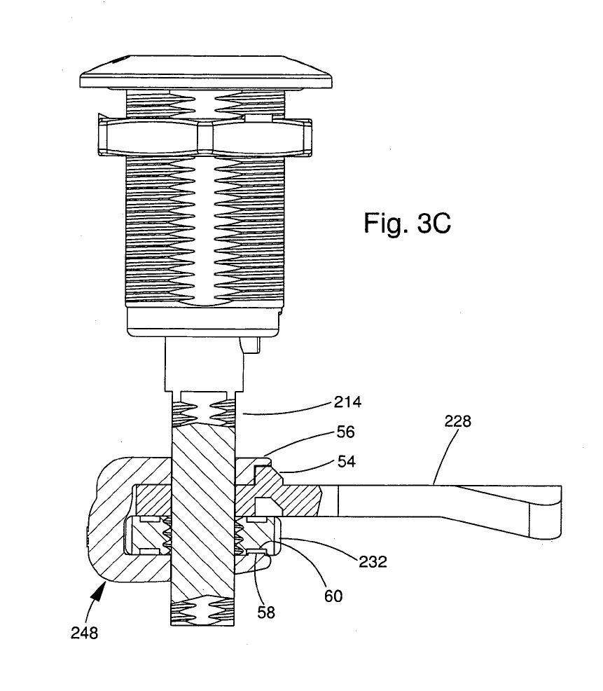

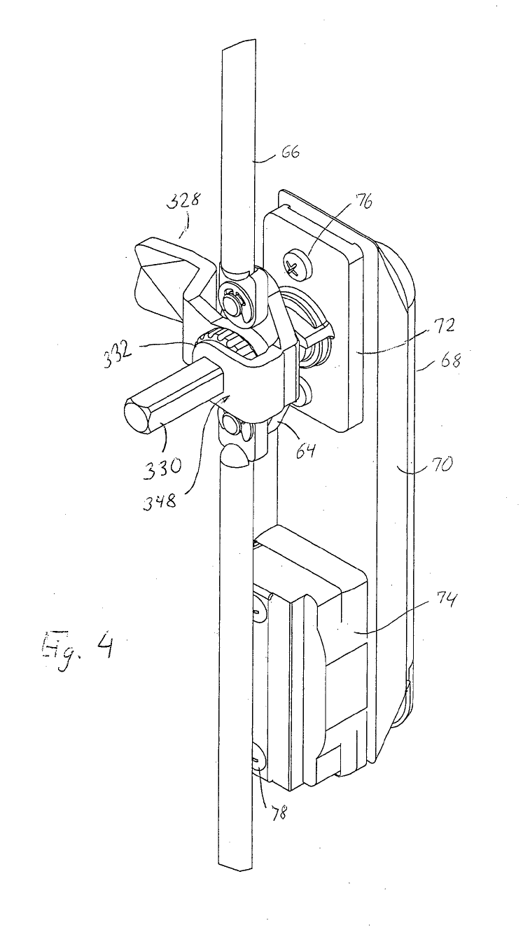

It can be seen in the embodiment form shown in FIG. 3A that the cage and the latch cam 228 are two parts. Accordingly, the cage 248 and the latch cam 228 can be made from different materials, e.g., plastic and metal. FIG. 3A also shows that the cage is U-shaped in this case, and the walls form the U-legs through which prismatic (particularly rectangular) bores 45 are guided in order to receive the shaft while preventing rotation. The latch 228 is likewise connected to the shaft 45 in a torsionally rigid manner.

Further, the latch 228 can be provided with a protuberance or recess. FIG. 3B shows that the cage is not only U-shaped and that the walls form U-legs (see reference numerals 50, 52) but also that the one leg 50 of the U-shaped cage forms a recess 56 close to its free end in which a projection 54 of the rotary latch 228 can be received in a positive engagement and accordingly produces a positively engaging rotational connection. The other leg 52 of the U-shaped cage forms a knob 58 which engages with recesses 60 in the contacting lateral surface of the nut 232 to prevent rotation. This prevents the knurled nut 232 from unwanted adjustment, e.g., during shaking movement.

As can be seen from FIG. 3B, the cage 248 is also U-shaped, and the nut 228 together with the rotary latch can be slid in along the axis of the legs of the U-shaped cage.

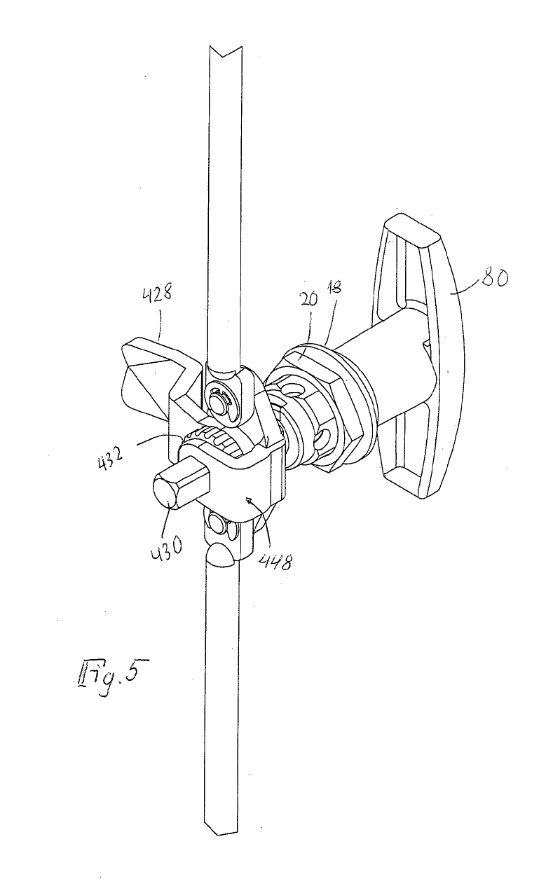

FIG. 4 shows a rotary latch 328 which is axially displaceable by means of a screw 332. Here, also, the nut is arranged in a cage 348 which is bounded by two ends, and the opening allows the shaft to be slid through in a torsionally rigid manner, and the shaft is driven by a swivel lever which propels the cage 348 and, further, has a double-arm. Locking rods are arranged at the arms and can be displaced axially by rotating the shaft 330. The shaft 330 is driven by a swivel lever 68. The swivel lever can be swiveled into a cavity 70 which can be installed in two apertures in the thin wall, specifically with a disk 72 and with a locking cylinder receptacle 74.

FIG. 5 shows a perspective view of a closure which has a construction similar to that of the closure shown in FIG. 4 and in which actuation is effected by means of a T-handle 80 which is fastened by means of a retainer nut in conventional manner as is shown in FIG. 1A.

### LIST OF REFERENCE NUMERALS

10 rotary latch closure
12 housing
14, 114, 214 actuating shaft
16 door leaf
18 flange
20 retainer nut
22 circumferential thread of the housing
24 circumferential thread of the shaft
26 flattened portion of the shaft
28, 128, 228 328, 428 rotary latch
30, 130, 230,
330, 430 free end of the shaft
32, 132, 232, 323, 432 knurled nut
34 door frame
36 ring
38 annular groove
40, 140, 240 prismatic bore
42 wall
44, 144 wall
46, 146 space
48, 148, 248, 348, 448 cage
50 U-leg
52 U-leg
54 projection/recess
56 recess/projection
58 knob
60 recesses
62 cam path
64 double-lever
66 lock rods
68 swivel lever
70 cavity
72 clamping plate
74 cylinder lock receptacle
76 clamping screw
78 clamping screw
80 T-handle

1. Rotary latch closure, particularly with key actuation, swivel lever actuation or T-handle actuation, comprising a housing (12) with an actuating shaft (14) which is mounted so as to be rotatable but axially fixed therein and which has at its free end (30) a circumferential thread (24) and at least one axially oriented flattened portion (26), and a rotary latch (28) which can be fitted to the free end (30) of the shaft so as to be fixed with respect to rotation relative to it in at least one rotational position and which is axially supported on a nut (32) which can be screwed onto the circumferential thread (24), characterized in that the nut (32) is enclosed by a cage (48) forming a laterally accessible space (46) that is bounded by two walls (42, 44), each of the two walls (42, 44) having a prismatic opening (40), wherein the opening allows the shaft (30) to be slid through in a torsionally rigid manner.

2. Rotary latch closure according to claim 1, characterized in that the cage (48) is integral with the latch cam (28).

3. Rotary latch closure according to claim 1, characterized in that the cage (48) and the latch cam (28) are two parts.

4. Rotary latch closure according to claim 3, characterized in that the cage (48) is U-shaped, and the U-legs (50, 52) form the walls (42, 44).

5. Rotary latch closure according to claim 4, characterized in that the one leg (50) of the U-shaped cage (48) forms a recess or projection (56) near its free end in which a projection or recess (54) of the rotary latch (28) can be received in a positive engagement.

6. Rotary latch closure according to claim 3, 4 or 5, characterized in that the other leg (52) of the U-shaped cage (48) forms a knob (58) which engages with recesses (60) in the contacting lateral surface of the nut (32) for preventing rotation.

7. Rotary latch closure according to claim 3, 4, 5 or 6, characterized in that the nut (32) has a circumferential knurling.

8. Rotary latch closure according to claim 7, characterized in that the walls (42, 44) of the cage (48) retract transverse to the extension of the latch (28) and make the knurling of the circumference of the nut (32) accessible.

9. Rotary latch closure according to claims 3 to 8, characterized in that the cage (48) is U-shaped, and in that the nut (32), together with the rotary latch (28), can be inserted into the cage (48) along the axis of the U-legs.

10. Rotary latch closure according to claims 1 to 8, characterized in that the rotary latch (28) is driven by a swivel lever (68).

11. Rotary latch closure according to claims 1 to 8, characterized in that the rotary latch (28) is driven by a T-handle (80).
